(19) United States
(12) Patent Application Publication
(10) Pub. No.: US 2004/0255724 A1
(43) Pub. Date: Dec. 23, 2004

(54) Ratchet wrench with a grip

(76) Inventor: Hsiu-Jen Lin, Yilan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/462,635

(22) Filed: Jun. 17, 2003

(51) Int. Cl. B25B 13/46

(52) U.S. Cl. 81/60

(57) ABSTRACT

A ratchet wrench with a grip that prevents the ratchet wrench from slipping out of a person's hands includes an elongated body, a ratchet device and a wrench head. The elongated body has two opposite ends and a central segment formed between the two ends of the elongated body. The ratchet device is mounted at one of the ends of the elongated body, and the wrench head is formed at the other end of the elongated body. The grip is mounted on the central segment of the elongated body to prevent the ratchet wrench from slipping out of a person's hands as the person uses the ratchet wrench to perform a task, such as tightening a fastener.

### BACKGROUND OF THE INVENTION

1. Field of the Invention

The present invention relates to a ratchet wrench, and more particularly to ratchet wrench having a grip that prevents the ratchet wrench from slipping out of a person's hand when the ratchet wrench tightens a fastener.

2. Description of Related Art

Wrenches are generally used to tighten fasteners, such as bolts or nuts to fasten things together. A ratchet wrench uses a ratchet device to tighten fasteners quickly. The ratchet device in a ratchet wrench turns the fasteners in one direction and allows a person to move the ratchet wrench in the opposite direction without disconnecting the wrench from the fastener. This allows the ratchet wrench to tighten fasteners quickly.

With reference to FIG. 9, a conventional ratchet wrench typically has an elongated body (60), a ratchet device (61) and an open end (62). The elongated body (60) has a gripping portion (601) and two opposite ends (not numbered). The ratchet device (61) is formed at one end of the elongated body (60), and the open end (62) is formed at the other end of the elongated body (60). The gripping portion (601) is formed between the two ends of the elongated body (60).

When a person uses the ratchet wrench to tighten a fastener (not shown), the person holds the gripping portion (601) to twist the ratchet wrench. However, since the elongated body (60) is fabricated by forging or casting, the gripping portion (601) is trimmed and smoothed to form a smooth surface without any burrs. Thereafter, a person who uses the ratchet wrench will not be injured by the burrs. However, smooth surface of the gripping portion (601) may cause a person's hands to slip on the ratchet wrench.

When a person is working on a machine, lubricants such as grease or oil in the machine will make the person's hands and the ratchet wrench especially slippery. Securely holding the ratchet wrench is not easy, and the ratchet wrench will tend to slip easily out of the person's hand and cause the person to be injured.

To overcome the shortcomings, the present invention provides a ratchet wrench with a grip to mitigate or obviate the aforementioned problems.

### SUMMARY OF THE INVENTION

The main objective of the invention is to provide a ratchet wrench with a grip that prevents the ratchet wrench from slipping out of a person's hands as the person uses the ratchet wrench to tighten a fastener.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a ratchet wrench with a grip in accordance with the present invention;

FIG. 2 is a perspective view of an alternative embodiment of a ratchet wrench in accordance with the present invention;

FIG. 3 is a cross sectional side plan view of the grip on the ratchet wrench in FIG. 1;

FIG. 4 is a cross sectional side plan view of a second embodiment of the grip in accordance with the present invention;

FIG. 5 is a cross sectional side plan view of a third embodiment of the grip in accordance with the present invention;

FIG. 6 is a perspective view of a fourth embodiment of the ratchet wrench with a grip in accordance with the present invention;

FIG. 7 is a cross sectional side plan view of the fourth embodiment of the grip in FIG. 6;

FIG. 8 is a cross sectional side plan view of a fifth embodiment of the grip in accordance with the present invention; and

FIG. 9 is a perspective view of a conventional ratchet wrench in accordance with the prior art.

### DETAILED DESCRIPTION OF PREFERRED EMBODIMENT

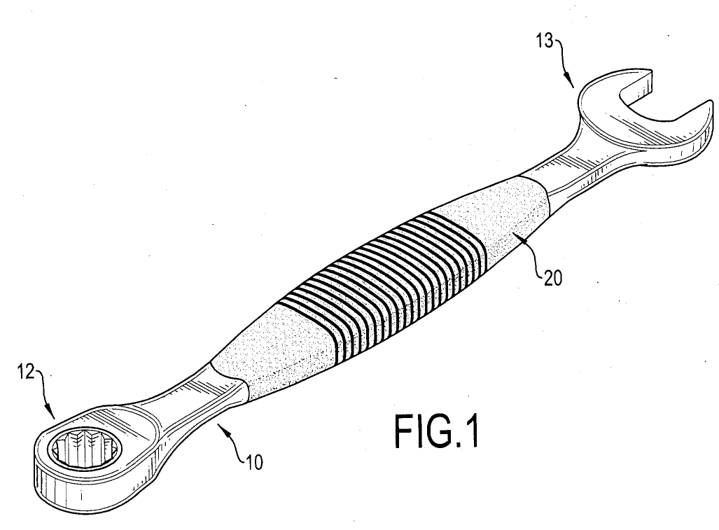

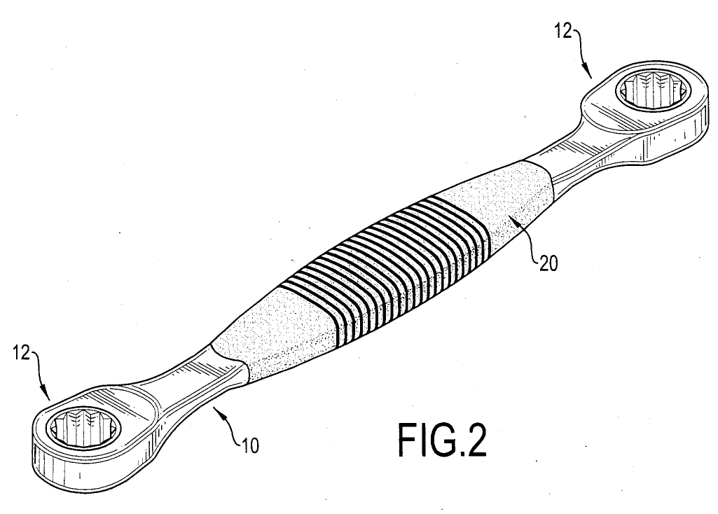

With reference to FIG. 1, a ratchet wrench with a grip (20) comprises an elongated body (10), a ratchet device (12) and a wrench head, such as a conventional open-end wrench head (13). The elongated body (10) has a first end (not numbered) and a second end (not numbered). The ratchet device (12) is mounted at the second end, and the open-end wrench head (13) is formed at the first end. With reference to FIG. 2, the wrench head can also be implemented with a conventional ratchet device (12) instead of an open-end wrench head (13). Since the ratchet devices (12) are conventional, no detailed description of the structure or operation is provided for the ratchet devices (12).

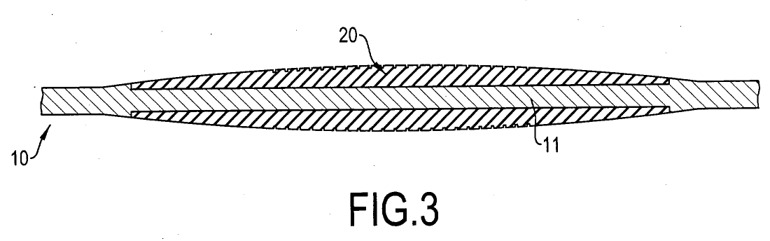

With reference to FIG. 3, the elongated body (10) further has a central segment (11) between the first and second ends. The central segment (11) has a primary recess (not numbered), a top (not numbered) and a bottom (not numbered). The primary recess is defined around the elongated body (10). The grip (20) is made of rubber, plastic or the like and is formed around the central segment (11) in the primary recess by molding or injection molding.

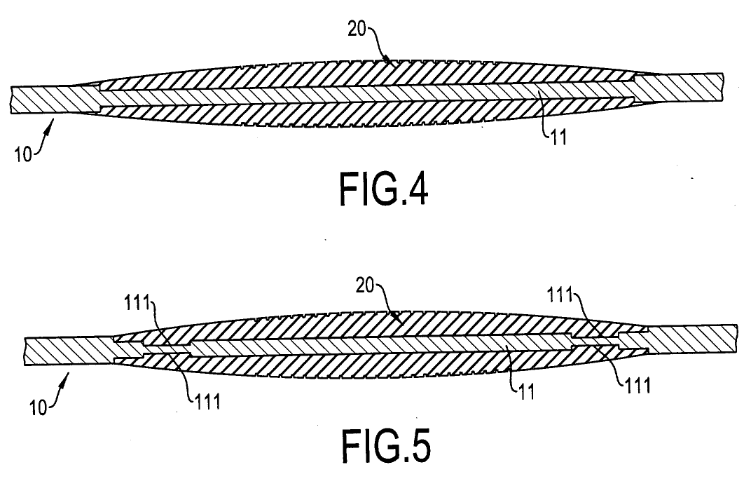

With reference to FIG. 4, a second embodiment of the grip (20) in accordance with the present invention extends beyond the primary recess toward the first and second ends to cover an additional portion of the central segment (11) of the elongated body (10). Thus, the ratchet wrench will have a grip (20) with a larger area so a person can hold the grip (20) easier.

With reference to FIG. 5, a third embodiment of the grip (20) in accordance with the present invention is mounted on an elongated body (10) that further has multiple secondary recesses (111) defined in the top and the bottom of the central segment (11) in the primary recess. The secondary recesses (111) are defined in the top and the bottom of the central segment (11) before the grip (20) is mounted on central segment (11). Therefore, the grip (20) has multiple protrusions (not numbered) that are respectively received in secondary recesses (111) after molding the grip (20). The secondary recesses (111) will engage the protrusions of the grip (20) to prevent the grip (20) from slipping on the central segment (11) in a longitudinal direction on the elongated body (10).

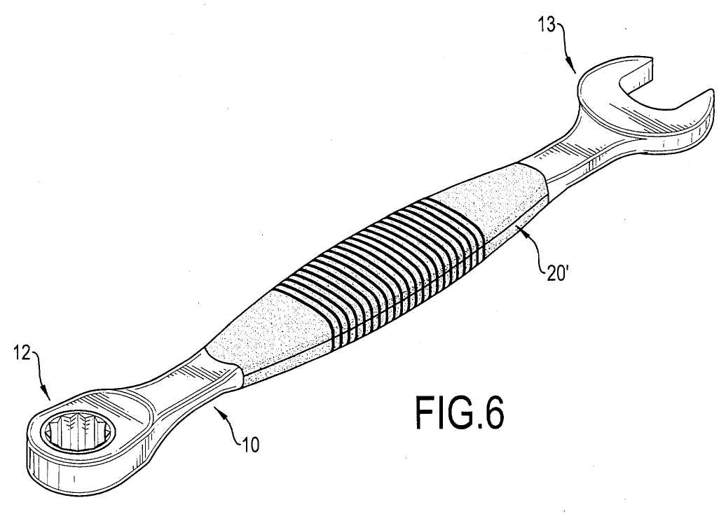

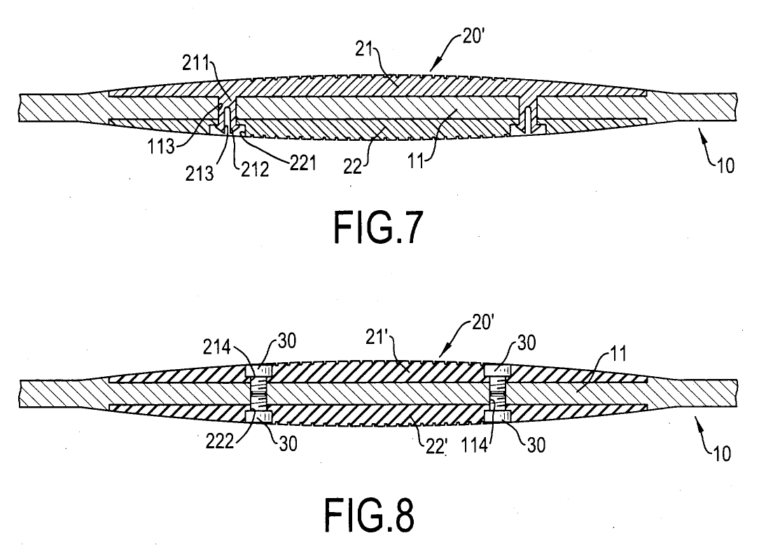

With reference to FIGS. 6 and 7, a fourth embodiment of the grip in accordance with the present invention for a ratchet wrench that comprises a modified grip (20′), an elongated body (10), a ratchet device (12) and an open-end wrench head (13). The ratchet device (12) and open-end wrench head (13) are the same as previously described. The elongated body (10) is the same except for two additional through holes (113) formed from the top to the bottom of the primary recess in the central segment (11).

The grip (20′) comprises an upper half (21) and a lower half (22) that are combined together around the primary recess in the central segment (11) of the elongated body (10). The upper half (21) is mounted on the top of the central segment (11) and has a bottom (not numbered), a top (not numbered), a longitudinal recess (not numbered) and two mounting stubs (211). The longitudinal recess is formed in the bottom of the upper half (21) and corresponds to the primary recess in the central segment (11) for securely holding the central segment (11). The two mounting stubs (211) are formed in the longitudinal recess, correspond to the two through holes (113) and extend downward. Each mounting stubs (211) has an enlarged head (212) and a longitudinal slit (213) defined through the enlarged head (212) to allow the enlarged head (212) to squeeze together and pass through the corresponding through hole (113).

The lower half (22) is attached to the bottom of the central segment (11) and has a top (not numbered), a bottom (not numbered), a longitudinal recess (not numbered) and two countersunk holes (221). The longitudinal recess is defined in the top of the lower half (22) and corresponds to the primary recess in the central segment (11) for securely holding the central segment (11). The two countersunk holes (221) are defined through the bottom the lower half (22) and correspond to the through holes (113) in the central segment (11). After the enlarged heads (212) pass respectively through the through holes (113) in the central segment (11), the enlarged heads (212) are pressed respectively through, extend out of and held in the countersunk holes (221). Consequently, the longitudinal recess in the lower half (22) cooperates with the longitudinal recess in the upper half (21) to hold the grip (20′) in the primary recess in the central segment (11).

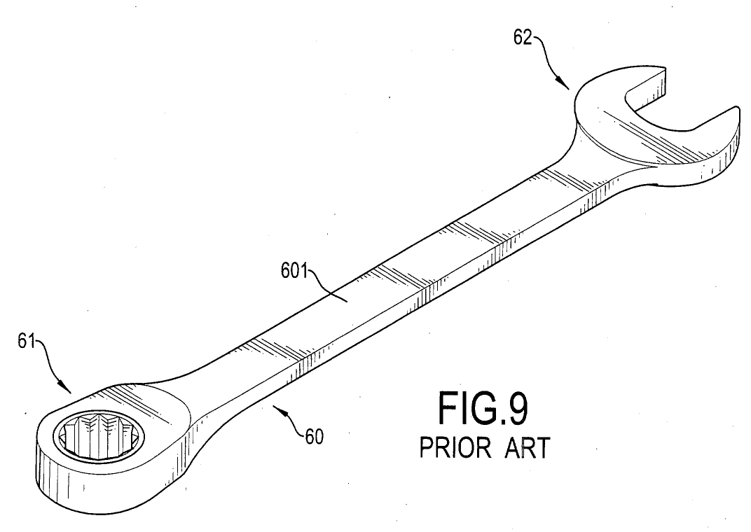

With reference to FIG. 8, a fifth embodiment of a grip in accordance with the present invention is implemented with a combination of features of the grip (20′) and the central segment (11) that have been previously described. The grip (20′) includes an upper half (21′) and a lower half (22′). The upper half (21′) has two upper countersunk holes (214), and the lower half (22′) has two lower countersunk holes (222). The upper and lower countersunk holes (214, 222) are aligned. The central segment (11) has two threaded through holes (114) that correspond-to the upper and the lower countersunk holes (214,222). The grip (20′) is mounted on the central segment (11) by inserting bolts (30) respectively through the upper and the lower countersunk holes (214, 222) and screwing the bolts (30) into the corresponding threaded through holes (114). The present invention provides a ratchet wrench that can be held securely by a person and reduce the possibility of injury to the person's hands.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A ratchet wrench comprising:
an elongated body having a first end, a second end and a central segment formed between the first and the second ends of the elongated body;
a ratchet device mounted at the second end of the elongated body;
a wrench head formed at the first end of the elongated body; and
a grip mounted on the central segment of the elongated body for preventing the ratchet wrench from slipping easily out of a person's hands.

2. The ratchet wrench as claimed in claim 1, wherein the wrench head is a ratchet device.

3. The ratchet wrench as claimed in claim 1, wherein the wrench head is an open-end wrench head.

4. The ratchet wrench as claimed in claim 1, wherein the central segment further has a top, a bottom and a primary recess defined around the central segment.

5. The ratchet wrench as claimed in claim 2, wherein the central segment further has a top, a bottom and a primary recess defined around the central segment.

6. The ratchet wrench as claimed in claim 3, wherein the central segment further has a top, a bottom and a primary recess defined around the central segment.

7. The ratchet wrench as claimed in claim 4, wherein the central segment further has at least one through hole defined through the top to the bottom of the central segment, and the grip further comprises
an upper half attached to the top of the central segment and having a bottom, a longitudinal recess defined in the bottom of the upper half and corresponding to the central segment for securely holding the central segment, and a mounting stub formed in the longitudinal recess and aligned with each respective one of the at least one through hole, each mounting stub having an enlarged head with a slit; and
a lower half attached to the bottom of the central segment and having a bottom, a top, a longitudinal recess formed in the top of the lower half and corresponding to the central segment for securely holding the central segment, and a countersunk hole defined through the bottom of the lower half and aligned with each respective mounting stub;
wherein the enlarged head of each mounting stub passes through and extends out of one of the at least one through hole in the central segment, and engages and is held in a corresponding one of the countersunk hole in the lower half.

8. The ratchet wrench as claimed in claim 5, wherein the central segment further has at least one through hole defined through the top to the bottom of the central segment, and the grip further comprises
an upper half attached to the top of the central segment and having a bottom, a longitudinal recess defined in the bottom of the upper half and corresponding to the central segment for securely holding the central segment, and a mounting stub formed in the longitudinal recess and aligned with each respective one of the at least one through hole, each mounting stub having an enlarged head with a slit; and
a lower half attached to the bottom of the central segment and having a bottom, a top, a longitudinal recess formed in the top of the lower half and corresponding to the central segment for securely holding the central segment, and a countersunk hole defined through the bottom of the lower half and aligned with each respective mounting stub;
wherein the enlarged head of each mounting stub passes through and extends out of one of the at least one through hole in the central segment, and engages and is held in a corresponding one of the countersunk hole in the lower half.

9. The ratchet wrench as claimed in claim 6, wherein the central segment further has at least one through hole defined through the top to the bottom of the central segment, and the grip further comprises
an upper half attached to the top of the central segment and having a bottom, a longitudinal recess defined in the bottom of the upper half and corresponding to the central segment for securely holding the central segment, and a mounting stub formed in the longitudinal recess and aligned with each respective one of the at least one through hole, each mounting stub having an enlarged head with a slit; and
a lower half attached to the bottom of the central segment and having a bottom, a top, a longitudinal recess formed in the top of the lower half and corresponding to the central segment for securely holding the central segment, and a countersunk hole defined through the bottom of the lower half and aligned with each respective mounting stub;
wherein the enlarged head of each mounting stub passes through and extends out of one of the at least one through hole in the central segment, and engages and is held in a corresponding one of the countersunk hole in the lower half.

10. The ratchet wrench as claimed in claim 4, wherein the central segment further has at least one threaded through hole defined through the top to the bottom of the central segment, and the grip further comprises
an upper half attached to the top of the central segment and having a bottom, a longitudinal recess defined in the bottom of the upper half and corresponding to the central segment for securely holding the central segment, and an upper countersunk hole corresponding to each respective one of the at least one threaded through hole; and
a lower half attached to the bottom of the central segment and having a top, a longitudinal recess defined in the top of the lower half and corresponding to the central segment for securely holding the central segment, and a lower countersunk hole corresponding to each respective one of the at least one threaded through hole; and
a bolt mounted in each respective one of the upper and the lower countersunk holes and screwed into a corresponding one of the at least one threaded through hole.

11. The ratchet wrench as claimed in claim 5, wherein the central segment further has at least one threaded through hole defined through the top to the bottom of the central segment, and the grip further comprises
an upper half attached to the top of the central segment and having a bottom, a longitudinal recess defined in the bottom of the upper half and corresponding to the central segment for securely holding the central segment, and an upper countersunk hole corresponding to each respective one of the at least one threaded through hole; and
a lower half attached to the bottom of the central segment and having a top, a longitudinal recess defined in the top of the lower half and corresponding to the central segment for securely holding the central segment, and a lower countersunk hole corresponding to each respective one of the at least one threaded through hole; and
a bolt mounted in each respective one of the upper and the lower countersunk holes and screwed into a corresponding one of the at least one threaded through hole.

12. The ratchet wrench as claimed in claim 6, wherein the central segment further has at least one threaded through hole defined through the top to the bottom of the central segment, and the grip further comprises
an upper half attached to the top of the central segment and having a bottom, a longitudinal recess defined in the bottom of the upper half and corresponding to the central segment for securely holding the central segment, and an upper countersunk hole corresponding to each respective one of the at least one threaded through hole; and
a lower half attached to the bottom of the central segment and having a top, a longitudinal recess defined in the top of the lower half and corresponding to the central segment for securely holding the central segment, and a lower countersunk hole corresponding to each respective one of the at least one threaded through hole; and
a bolt mounted in each respective one of the upper and the lower countersunk holes and screwed into a corresponding one of the at least one threaded through hole.

13. The ratchet wrench as claimed in claim 4, wherein the central segment further has multiple secondary recesses defined respectively in the top and the bottom of the central segment in the primary recess; and
the grip has multiple protrusions respectively engaged in the secondary recesses in the central segment.

14. The ratchet wrench as claimed in claim 5, wherein the central segment further has multiple secondary recesses defined respectively in the top and the bottom of the central segment in the primary recess; and
the grip has multiple protrusions respectively engaged in the secondary recesses in the central segment.

15. The ratchet wrench as claimed in claim 6, wherein the central segment further has multiple secondary recesses defined respectively in the top and the bottom of the central segment in the primary recess; and
the grip has multiple protrusions respectively engaged in the secondary recesses in the central segment.
